(19) United States
(12) Patent Application Publication
(10) Pub. No.: US 2008/0204924 A1
(43) Pub. Date: Aug. 28, 2008

(54) Information recording device

(76) Inventors: Jun Ohno, Kanagawa (JP); Atsushi Yatagai, Kanagawa (JP); Satoshi Ohki, Kanagawa (JP); Hiroshi Ide, Tokyo (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/072,001

(22) Filed: Feb. 21, 2008

(30) Foreign Application Priority Data
Feb. 21, 2007 (JP) 2007-040464

(51) Int. Cl. G11B 21/02

(52) U.S. Cl. 360/75

(57) ABSTRACT

Embodiments of the present invention help to compute controlling quantity to make the spacing between a floating head slider and a recording medium optimum without damaging the floating head slider and the recording medium by detecting the floating head slider's contact with the recording medium with high sensitivity. According to one embodiment, when the floating head slider is floating over the magnetic disk, a controller takes samples of a notable characteristic value (amplitude) from signals reproduced by a reproducing head, retains the variation of the sample amplitude as a reference signal, takes samples of amplitude from signals reproduced by the reproducing head while reducing the spacing between the floating head slider and the magnetic disk gradually, produces a signal which is the sample signal from which the reference signal is subtracted, detects the floating head slider's contact with the magnetic disk when the fluctuation of the signal so produced exceeds a reference value and, on the basis of a fly-height-control mechanism's controlling quantity at the time of the contact, computes the controlling quantity for making the spacing between the floating head slider and the magnetic disk optimum.

### CROSS-REFERENCE TO RELATED APPLICATION

The instant nonprovisional patent application claims priority to Japanese Patent Application No. 2007-040464 filed Feb. 21, 2007 and which is incorporated by reference in its entirety herein for all purposes.

### BACKGROUND OF THE INVENTION

To increase the data-recording density of a hard disk, it is necessary to reduce the spacing between a recording/reproducing head and a magnetic film of the hard disk. On the other hand, reducing the spacing increases the risk of the head touching the disk and damaging it. Thus, the reliability of the hard disk is reduced. While maintaining the reliability and reading and writing data, the spacing should be as small as possible. Therefore, it is necessary to reduce the mechanical variation of the spacing between the head and the disk due to environmental variations such as the variations of atmospheric pressure and temperature and manufacturing errors such as dimensional errors of the floating surface of the floating head slider. Accordingly, an art to dynamically control the spacing after the hard disk being mounted was developed. To make the best use of the art, it is necessary to determine the spacing between the head and the disk accurately. The spacing can be determined accurately by reducing the spacing gradually until the head touches the disk and treating the touch point as the datum, or basis for measurement. According to this method, the spacing margin for manufacturing errors and environmental variations can be dispensed with and, therefore, data can be recorded and reproduced with a smaller spacing on the average.

According to the above method, however, because the head is put into contact with the disk once, there may be damage due to the contact. To minimize the risk, it is important to detect the heads' contact with the disk with high sensitivity.

Disclosed in Japanese Patent Publication No. 2002-74686 (“Patent document 1”) is an approach to detect such contact. That is, according to the art disclosed in Patent document 1, an optical disk device of the art comprises: an actuator which has a first objective lens and approaches and leaves a disk-type recording medium under focusing control; and a floating slider which has a second objective lens and moves along with the actuator and is floated over the surface of the disk-type recording medium by an airflow caused by the rotation of the disk-type recording medium. Signals are produced by removing the components of frequencies in the vicinity of the rotational frequency of the disk-type recording medium from the level changes of the focusing-error signals of the first and second objective lenses and comparing the signals so produced with a reference level to move the floating slider away from the surface of the recording medium.

Disclosed in Japanese Patent Publication No. 2005-4909 (“Patent document 2”) is a magnetic disk device with an actuator which moves slightly. The heads' contact with the disk is detected by monitoring the output signals from the slightly-moving actuator. Besides, in this regard, a method of detecting the contact by monitoring frequencies other than the natural frequency of the mechanical system is disclosed.

As described above, in the case of the method of estimating the fly-height of the head by detecting the head's contact with the disk, the head and the disk may be damaged by the contact. To minimize the risk, it is important to detect the head's slight contact with the disk with high sensitivity while the fly-height of the head is decreased. The detecting power can be improved by monitoring the variation of reproduced signals. It is difficult, however, to set a boundary between the variations in the steady state and the variations at the time of contact because the inherent system noise of the device is superimposed on those variations. As a result, the head is put into contact with the disk for a long time, which increases the risk of damaging the head and the disk.

### BRIEF SUMMARY OF THE INVENTION

An object in accordance with embodiments of the present invention is to compute controlling quantity to make the spacing between a floating head slider and a recording medium optimum without damaging the floating head slider and the recording medium by detecting the floating head slider's contact with the recording medium with high sensitivity.

According to the particular embodiment disclosed in FIG. 5, when the floating head slider 3 is floating over the magnetic disk 1, a controller takes samples of a notable characteristic value (amplitude) from signals reproduced by a reproducing head 3b, retains the variation of the sample amplitude as a reference signal, takes samples of amplitude from signals reproduced by the reproducing head while reducing the spacing between the floating head slider and the magnetic disk gradually, produces a signal which is the sample signal from which the reference signal is subtracted, detects the floating head slider's contact with the magnetic disk when the fluctuation of the signal so produced exceeds a reference value and, on the basis of a fly-height-control mechanism's controlling quantity at the time of the contact, computes the controlling quantity for making the spacing between the floating head slider and the magnetic disk optimum.

### BRIEF DESCRIPTION OF THE DRAWINGS

FIG. 1 is a flowchart of processing to compute the fly-height controlling quantity in the magnetic disk device of Example 1.

FIG. 2 is a flowchart of processing to compute the fly-height controlling quantity of the magnetic disk device of Example 2.

FIG. 3 is a flowchart of processing to compute the fly-height controlling quantity in the magnetic disk device of Example 3.

FIG. 4 is a schematic block diagram of the magnetic disk device according to an embodiment of the present invention.

FIG. 5 is an illustration of the floating head slider according to an embodiment of the present invention.

FIG. 6 shows amplitudes of signals reproduced during one turn of the disk at different electric-power levels of the heater.

FIG. 7 shows amplitudes of signals reproduced during one turn of a vertical magnetic recording medium.

FIG. 8 shows the fluctuation of sample signals and that of sample signals from which components whose frequencies are not higher than five times the rotational frequency of the magnetic disk are removed.

FIG. 9 shows the result of the splitting of the signals reproduced during one turn of the disk of FIG. 6 through Fourier transform (FFT).

### DETAILED DESCRIPTION OF THE INVENTION

Embodiments of the invention relate to an information recording device, and particularly to a magnetic disk device with a mechanism to control the fly-height of a floating head slider.

Embodiments of the present invention were made under the above circumstances. Specifically, an object of embodiments of the present invention is to provide an information recording device wherein (i) the spacing between the floating head slider and the recording medium is dynamically controlled, and (ii) controlling quantity to make the spacing between the floating head slider and the recording medium optimum is computed without damaging the floating head slider and the recording medium by detecting the floating head slider's contact with the recording medium with high sensitivity.

In order to achieve the above object, according to a first feature of embodiments of the present invention, there is provided an information recording device which comprises (i) a recording medium, (ii) a floating head slider with a recording head, a reproducing head, and a fly-height-control mechanism, and (iii) a controller for controlling the fly-height-control mechanism, wherein, when the floating head slider is floating over the recording medium, the controller (i) takes samples of a notable characteristic value from signals reproduced by the reproducing head, (ii) retains the variation of the sample characteristic value as a reference signal, (iii) takes samples of the notable characteristic value from signals reproduced by the reproducing head while reducing the spacing between the floating head slider and the recording medium gradually, (iv) produces a signal which is the sample characteristic value from which the reference signal is subtracted, (v) detects the floating head slider's contact with the recording medium when the fluctuation of the signal so produced exceeds a reference value, and (vi) computes the fly-height-control mechanism's controlling quantity for making the spacing between the floating head slider and the recording medium optimum on the basis of the controlling quantity of the fly-height-control mechanism at the time of detecting the contact and retains the controlling quantity so computed.

It may be desirable that the above notable characteristic value is one of the amplitude of reproduced signals, the waveform of reproduced signals, timing jitters, and position data.

It may be desirable that the fly-height-control mechanism's controlling quantity for making the spacing between the floating head slider and the recording medium optimum is computed after the assembly of the information recording device.

According to a second feature of embodiments of the present invention, the controller of the information recording device (i) takes samples of a notable characteristic value from signals reproduced by the reproducing head while reducing the spacing between the floating head slider and the recording medium gradually, (ii) produces a signal which is the sample characteristic value from which components, whose frequencies are not higher than five times the rotational frequency of the recording medium, are removed, (iii) detects the floating head slider's contact with the recording medium when the fluctuation of the signal so produced exceeds a reference value, and (iv) computes the fly-height-control mechanism's controlling quantity for making the spacing between the floating head slider and the recording medium optimum on the basis of the controlling quantity of the fly-height-control mechanism at the time of detecting the contact and retains the controlling quantity so computed.

According to a third feature of embodiments of the present invention, the controller of the information recording device (i) takes samples of a notable characteristic value from signals reproduced by the reproducing head while reducing the spacing between the floating head slider and the recording medium gradually, (ii) produces a signal which is the sample characteristic value from which components of frequencies in the vicinity of the resonance frequency of the floating head slider are extracted, (iii) detects the floating head slider's contact with the recording medium when the fluctuation of the signal so produced exceeds a reference value, and (iv) computes the fly-height-control mechanism's controlling quantity for making the spacing between the floating head slider and the recording medium optimum on the basis of the controlling quantity of the fly-height-control mechanism at the time of detecting the contact and retains the controlling quantity so computed.

According to embodiments of the present invention, contact between the floating head slider and the information recording medium can be detected without damaging them, and controlling quantity for making the spacing between the floating head slider and the information recording medium optimum can be computed on the basis of the condition at the time of detecting the contact.

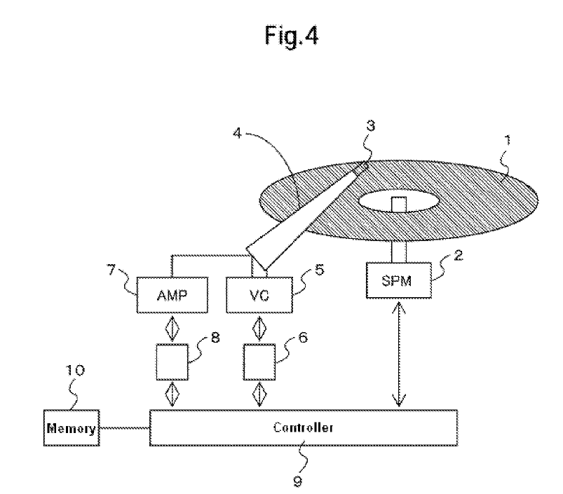

By referring to drawings, preferred embodiments of the present invention will be described. FIG. 4 is a schematic block diagram of an information recording device (magnetic disk device) according to an embodiment of the present invention. The magnetic disk device comprises a recording medium (magnetic disk) 1, a spindle motor (SPM) 2, a floating head slider 3, a carriage assembly 4, a voice coil motor (VCM) 5, a VCM controller 6, a preamplifier (AMP) 7, a read/write channel 8, a controller 9, and a memory 10. The magnetic disk 1 is mounted on, and driven by, the SPM 2. Formed on the magnetic disk 1 are tracks in the shapes of concentric circles. Each track has servo-data sections and user-data sections arranged circumferentially of the track. Recorded in the servo-data sections are servo-address data to be used in order to move the floating head slider 3 to certain tracks for recording and reproduction and servo-burst data to be used in order to position the recording and reproducing heads over the certain tracks after being moved there.

As shown in FIG. 5, the floating head slider 3 is provided with a recording head 3a magnetically recording data on the magnetic disk 1 and a reproducing head 3b reproducing the recorded data, both disposed on the air flow-out side. In addition, the floating head slider 3 is provided with a fly-height-control mechanism (heater) 3c which controls the spacing (fly-height) between the recording/reproducing elements and the magnetic disk 1 by making use of deformation caused by thermal expansion.

The preamplifier 7 receives signals representing data to be recorded through the read/write channel 8, amplifies them, and feeds them to the recording head 3a of the floating head slider 3. Besides, the preamplifier 7 amplifies the signals reproduced by the reproducing head 3b and outputs them. Moreover, the preamplifier 7 of the present embodiment receives a signal representing an electric-current value (controlling quantity) and feeds an electric current (or voltage or electric power) of the inputted electric-current value to the heater 3c. Provided between the floating head slider 3 and the read/write channel 8 is a flexible cable (FPC) 11 to cope with the rotational motion caused by the VCM 5. The preamplifier 7 is fitted onto the FPC 11 with solder.

As shown in FIG. 4, the floating head slider 3 is mounted on the carriage assembly 4 and moves over the magnetic disk 1 to record data onto the magnetic disk 1 with the recording head 3a and reproduce data from the magnetic disk 1 with the reproducing head 3b. The VCM controller 6 controls the carriage assembly 4 through the VCM 5 to move the floating head slider 3 over the magnetic disk 1.

The read/write channel 8 encodes signals from the controller 9 and feeds the encoded signals to the preamplifier 7 as electric signals. The read/write channel 8 also decodes reproduced signals from the reproducing head 3b through the preamplifier 7 and feeds the decoded signals to the controller 9. The controller 9, through the read/write channel 8 of the present embodiment, controls the spacing between the floating head slider 3 and the magnetic disk 1.

The controller 9 may be a microprocessor and functions in accordance with a program stored in the memory 10. The controller 9 receives data to be recorded from a host computer of the magnetic disk device and feeds the data to the read/write channel 8. The controller 9 outputs signals to the VCM controller 6 so as to move the floating head slider 3 to data-recording positions on the magnetic disk 1. According to the present embodiment, when data is recorded or reproduced, the floating head slider 3 is moved under the control of the VCM controller 6 to an address on a track designated by the servo data.

Besides, when the controller 9 receives instructions from the host computer to read out data from the magnetic disk 1, it outputs a signal to the VCM controller 6 so as to move the floating head slider 3 to the address related to the instruction where the data is recorded and, then, receives decoded signals from the read/write channel 8 and feeds them to the host computer.

In summary, the magnetic disk device is connected to the host computer and receives (i) instructions from the host computer to record data and (ii) electric signals representing the data to be recorded and, then, the controller 9 feeds the data to be recorded to the read/write channel 8, which encodes the data and feeds the it to the preamplifier 7, which produces the electric signals, and the recording head 3a converts the electric signals into magnetic signals and magnetizes the magnetic disk 1 to record the data onto it.

On the other hand, when the magnetic disk device receives instructions from the host computer to read out data from the magnetic disk 1, the controller 9 outputs a signal to the VCM controller 6, which controls the carriage assembly 4 through the VCM 5 to move the floating head slider 3 to the address where the data are recorded. The reproducing head 3b of the floating head slider 3 reads out the recorded data and feeds the data signals to the preamplifier 7, which amplifies the data signals and feeds the amplified data signals to the read/write channel 8, which decodes the data signals and feeds the decoded data signals to the controller 9, which feeds the decoded data signals to the host computer.

Operation of the controller 9 will be described. When data are to be recorded, the controller 9, following a prescribed procedure and taking environmental conditions into account, gives the read/write channel 8 instructions to make the spacing between the magnetic disk 1 and the floating head slider 3 optimum. According to the instructions, the read/write channel 8 controls the fly-height-control mechanism 3c to control the spacing. With the spacing controlled to be optimum, data are recorded onto concentric tracks on the magnetic disk 1. Similar processing is carried out to read out data. Thus, data can be recorded densely and reproduced efficiently.

According to the present embodiment, after the assembly of the magnetic disk device but before its shipment, or at prescribed intervals, or when the magnetic disk device lies idle, the controller 9 estimates environmental factors and the spacing and computes the controlling quantity (electric-power value) of the fly-height-control mechanism for making the spacing optimum. To estimate the spacing, it is set wide enough first, and then gradually narrowed. While the spacing is gradually narrowed, reproduced signals are monitored to detect the floating head slider 3's contact with the magnetic disk 1. The electric-power value of the fly-height-control mechanism at the time of the contact is treated as the datum, or basis for measurement, and the spacing is computed backward from the datum. The backward computation of the original spacing (fly-height) requires the proportional coefficient, or “spacing-reducing efficiency,” between the electric-power value and the change of fly-height. As for the “spacing-reducing efficiency,” a value peculiar to the floating head slider may be calculated from Wallace's formula of spacing loss during the inspection before shipment. Alternatively, a typical value found beforehand by simulation or a sample test may be used.

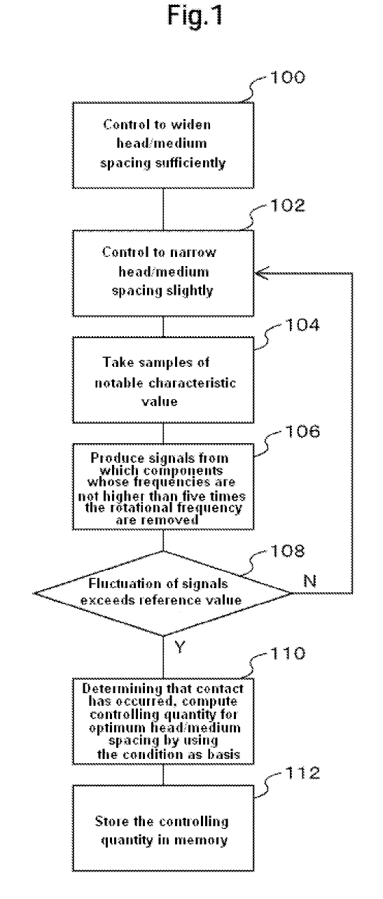

With reference to FIG. 1, a flow of processing by the controller 9 of the magnetic disk device of Example I will be described in detail. First, in Step 100, the fly-height-control mechanism 3c is controlled to widen the spacing between the floating head slider 3 and the magnetic disk 1 sufficiently. For example, the electric power of the heater 3c is reduced to zero. In this state, in Step 104, samples of amplitude are taken, as a notable characteristic value, from the signals reproduced by the reproducing head 3b at a speed high enough relative to the rotational frequency of the magnetic disk 1. The frequencies of components of amplitude fluctuation of reproduced signals due to the contact of the floating head slider 3 are higher enough than the rotational frequency of the magnetic disk 1; therefore, in Step 106, signals which are the sample signals from which components of low frequencies are removed are produced. It is desirable that a high-pass filter for removing the components of low frequencies is, for example, capable of removing components whose frequencies are not higher than five times the rotational frequency of the magnetic disk 1. Then, in Step 108, the fluctuation of the produced signals is quantified by using such an index as variance. It is determined whether or not the quantified fluctuation is equal to or more than a prescribed reference value. If it is below the prescribed reference value, it is determined that the contact has not occurred. In Step 102, the spacing between the head and the disk is narrowed to a value slightly smaller than the sampling condition, and the above measurement is repeated. When it is determined in Step 108 that quantified fluctuation exceeds the prescribed reference value, in Step 110, it is determined that the contact has occurred. Then, the condition (the electric-power value of the heater 3c) on which the determination of the occurrence of the contact is based is treated as the datum, or basis, and the spacing of the floating head slider 3 is computed backward. The electric-power value of the heater 3c at which the spacing between the head and the disk is controlled to be optimum in the magnetic disk device is found according to the spacing computed backward. Then, in Step 112, the electric-power value so computed is stored in the memory 10.

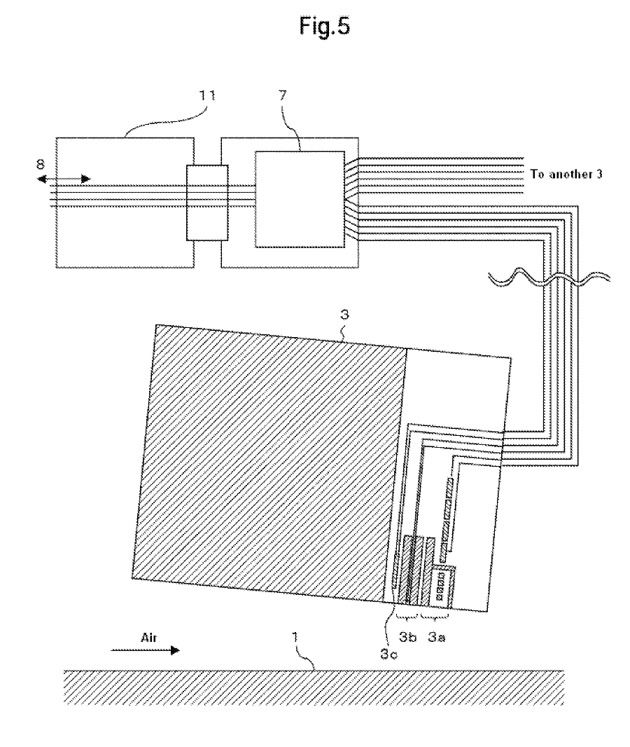

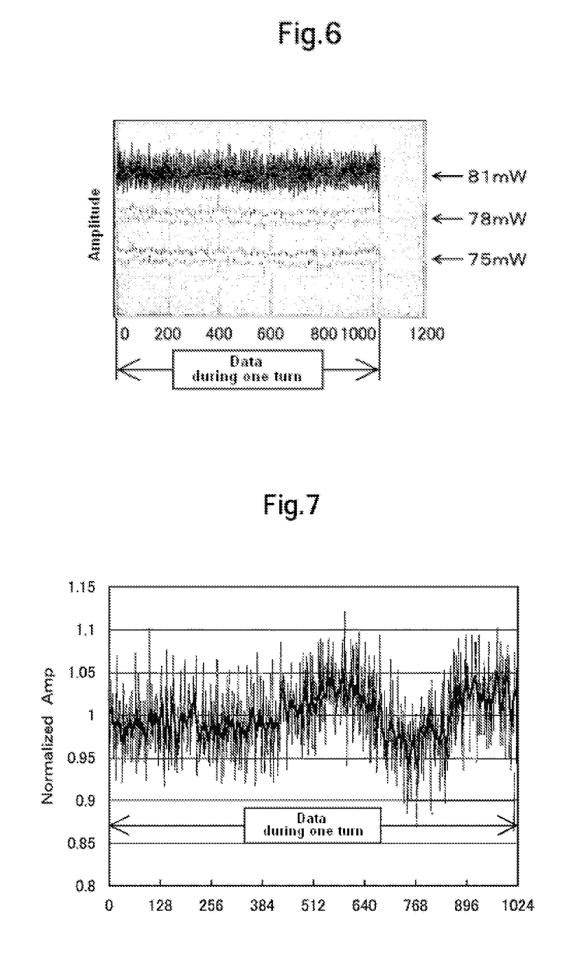

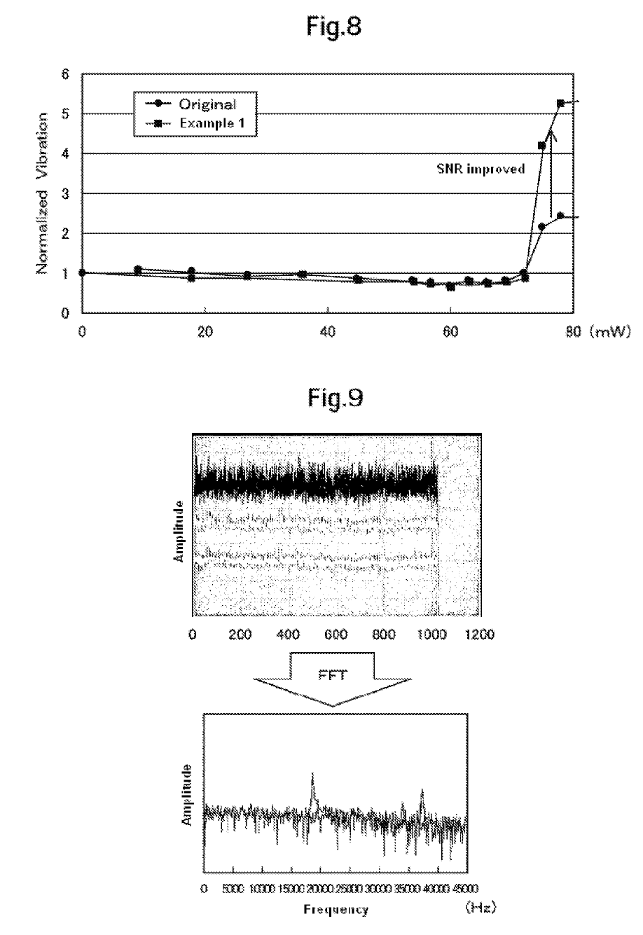

FIG. 6 shows amplitudes of signals reproduced during one turn of the disk when the electric-power value of the heater 3c is varied. The x-axis represents the points of sampling (1,024 points); the y-axis, amplitude. When the electric power of the heater 3c is 75 mW and 78 mW, the amplitude is small, indicating that the floating head slider 3 has yet to touch the magnetic disk 1. When the electric power is 81 mW, the amplitude abruptly becomes very large, indicating that the floating head slider 3 has touched the magnetic disk 1. However, it is seen that these amplitude data also contain low-frequency noise due to the rotation of the magnetic disk. FIG. 7 shows amplitude data of signals reproduced during one turn of a vertical magnetic recording medium. It is clearly seen that there is a low-frequency swell due to the circumferential unevenness of magnetism of the recording medium. When there exists the low-frequency noise due to the rotation of the magnetic disk, such noise reduces the sensitivity in detecting the floating head slider's contact with the magnetic disk. Therefore, in the above processing, removed from the sample signal are components whose frequencies are not higher than five times the rotational frequency of the magnetic disk. FIG. 8 shows the fluctuation of (original) sample signals and that of sample signals from which components whose frequencies are not higher than five times the rotational frequency of the magnetic disk are removed. The x-axis shows the electric power of the heater 3c; the y-axis, the fluctuation quantified by variance. As shown in FIG. 8, the SNR is remarkably improved by removing components whose frequencies are not higher than five times the rotational frequency of the magnetic disk.

As described above, according to the contact detection in Example 1, because low-frequency noise due to the rotation of the magnetic disk is removed by removing, from sample signals, components whose frequencies are not higher than five times the rotational frequency of the magnetic disk, the floating head slider's contact with the magnetic disk can be detected with high sensitivity.

If the above processing is made after the assembly of the magnetic disk device but before its shipment, the controller can control the fly-height-control mechanism by using the electric-power value stored in the memory so as to make the spacing between the floating head slider and the magnetic disk, or floating amount of the floating head slider, optimum when the magnetic disk device is turned on. If the above processing is made at regular intervals or while the magnetic disk device is idle after the shipment of the magnetic disk device, the controller can control the fly-height-control mechanism by using the electric-power value stored in the memory, until the next processing, so as to make the spacing between the head and the disk optimum.

In Example 1, although the amplitude of reproduced signals is chosen as a notable characteristic value, the waveform of reproduced signals, timing jitters, position data, etc. may be chosen as other items to be sampled. Desirable methods of taking samples of notable characteristic values will be as follows.

Method of Taking Samples of Amplitude of Reproduced Signals:

(1) The AGC gain of the read/write channel 8 is monitored.
(2) User-data sections or servo-data sections or both the user-data and servo-data sections of the tracks are monitored.
(3) Periodic sampling is made.
(4) To be precise, a periodic sampling is regarded as pseudo-periodic sampling.

Method of Taking Samples of Waveform of Reproduced Signals:

(1) The coefficient of the adaptively functioning filter of the read/write channel 8 is monitored.
(2) The variation (change) of resolution is monitored.
(3) The asymmetry of waveform of reproduced signals with respect to the x-axis is monitored.
(4) The errors in equalization of waveform are monitored at the read/write channel 8.
(5) The quantity of noise is monitored at the read/write channel 8.
(6) The bit error rate is monitored.

Method of Taking Samples of Timing Jitters:

(1) The result of the phase-lock loop of the read/write channel is monitored.

Method of Taking Samples of Position Data:

(1) Position signals are produced from position data stored in the medium and the fluctuation of the signals is monitored.

In Example 1, variance is used as a method to quantify fluctuation. However, the maximum value of signals may be used by using a comparator.

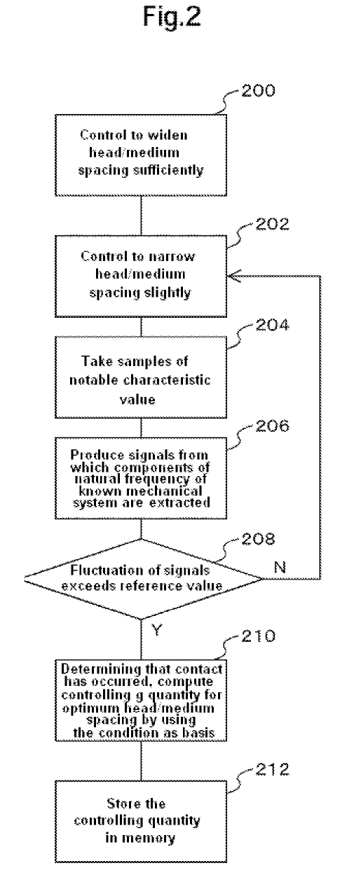

With reference to FIG. 2, a flow of the processing by the controller 9 of the magnetic disk device of Example 2 will be described. First, in Step 200, as in Example 1, the spacing between the head and the medium is controlled to be sufficiently widened. In this state, in Step 204, samples of amplitude are taken, as a notable characteristic value, from the reproduced signals at a speed high enough relative to the rotational frequency of the medium. The natural frequency of the floating head slider 3 mounted at the end of the carriage assembly 4 is sufficiently higher than the rotational frequency of the medium. Contact between the floating head slider 3 and the medium causes the floating head slider 3 to vibrate at its natural frequency. The vibration of the floating head slider 3 is in synchronism with the fluctuation of reproduced signals; therefore, in Step 206, signals which are the sample signals from which the components of frequencies in the vicinity of the natural frequency are extracted are produced. It is desirable that the band width of a band-pass filter used for the above extraction is not more than 10% of the natural frequency. Then, in Step 208, the fluctuation of the produced signals is quantified by using such an index as variance. Then, it is determined whether or not the quantified fluctuation exceeds a prescribed reference value. If it has exceeded the prescribed reference value, it is determined that the contact has occurred. If it is determined that the contact has not occurred, in Step 202, the spacing between the head and the medium is narrowed to a value slightly smaller than the sampling condition, and the above measurement is repeated. The above procedure is repeated until it is determined that the contact has occurred. In Step 208, if it is determined that the quantified fluctuation exceeds the reference value, in Step 210, it is determined that the contact has occurred. Then, the condition (the electric-power value of the heater 3c) on which the determination of the occurrence of the contact is based is treated as the datum, or basis, and the spacing of the floating head slider 3 is computed backward. The electric-power value of the heater 3c at which the spacing between the head and the disk is controlled to be optimum in the magnetic disk device is found according to the spacing computed backward. Then, in Step 212, the electric-power value so computed is stored in the memory 10.

FIG. 9 shows the result of the splitting of the signals reproduced during one turn of the disk in FIG. 6 over a frequency range through fast Fourier transform (FFT). It can be seen that the floating head slider's contact with the magnetic disk caused the floating head slider to resonate. Thus, in the second embodiment, the frequency band of the resonance is extracted to detect the floating head slider's contact with the magnetic disk with high sensitivity.

Although the example of taking samples of the amplitude of reproduced signals is also shown in Example 2, as in Example 1, the waveform of reproduced signals, timing jitters, position data, etc. may be chosen.

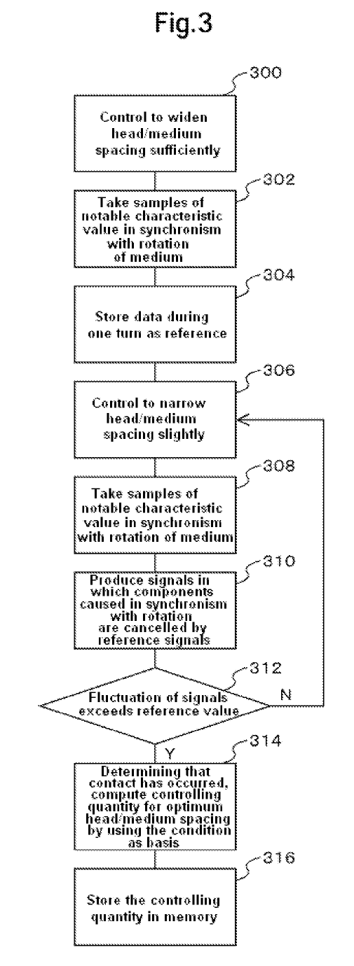

With reference to FIG. 3, a flow of the processing by the controller 9 of the magnetic disk device of Example 3 will be described. First, in Step 300, as in Example 1, the spacing between the head and the medium is controlled to be sufficiently widened. In this state, it is regarded that the head is stably floating over the medium and has not contacted with the medium. In Step 302, samples of amplitude are taken, as a notable characteristic value, from the reproduced signals in synchronism with the rotation of the medium, at a speed high enough relative to the rotational frequency of the medium. In Step 304, the sample signals during one turn are stored as reference signals. However, it is more desirable to take samples from the signals reproduced during more than one turn, take the averages at positions in synchronism with the rotation, and store the averages as reference signals. From this point (Step 306), the spacing between the head and the disk is narrowed slightly, and samples of amplitude are taken from reproduced signals (Step 308). There are produced signals which are the sample signals from which various noises due to the rotation of the medium have been subtracted by using the reference signals (Step 310). The fluctuation of the produced signals is quantified by using such an index as variance. If it exceeds the prescribed reference value, it is determined that the contact has occurred (Step 312). If it is determined that the contact has not occurred, in Step 306, the spacing between the head and the medium is narrowed to a value slightly smaller than the sampling condition, and the above measurement is repeated. The above procedure is repeated until it is determined that the contact has occurred. In Step 312, if it is determined that the quantified fluctuation exceeds the reference value, in Step 314, it is determined that the contact has occurred. Then, the condition (the electric-power value of the heater 3c) on which the determination of the occurrence of the contact is based is treated as the datum, or basis, and the spacing of the floating head slider 3 is computed backward. The electric-power value of the heater 3c at which the spacing between the head and the disk is controlled to be optimum in the magnetic disk device is found according to the spacing computed backward. Then, in Step 316, the electric-power value so computed is stored in the memory 10.

In the processing according to Example 3, too, various noises due to the rotation of the medium are subtracted from the amplitude of reproduced signals by using the reference signal. Therefore, the floating head slider's contact with the magnetic disk can be detected with high sensitivity.

Further, two or three of the above examples may be adopted at the same time. Besides, two or more of the items to be sampled may be chosen. In such a case, the contact can be detected with higher sensitivity. For example, Examples 1 and 2 can be implemented in such a way that reference signals are produced and the reference signals are subtracted from sample reproduced signals in the first place and, then, the signals are subjected to the processing of Example 1 or Example 2.

What is claimed is:

1. An information recording device comprising:
a recording medium on which information is recorded and retained;
a floating head slider provided with a recording head by which information is recorded on said recording medium, a reproducing head by which information is reproduced from said recording medium, and a fly-height-control mechanism for controlling the distance to said recording medium; and
a controller for controlling said fly-height-control mechanism,
wherein, when said floating head slider is floating over said recording medium, said controller is configured to take samples of a notable characteristic value from signals reproduced by said reproducing head, retain the variation of the sample characteristic value as a reference signal, take samples of the notable characteristic value from signals reproduced by said reproducing head while reducing the spacing between said floating head slider and the recording medium gradually, produce a signal which is the sample characteristic value from which said reference signal is subtracted, detects said floating head slider's contact with the recording medium when the fluctuation of the signal so produced exceeds a reference value, and compute the fly-height-control mechanism's controlling quantity for making the spacing between said floating head slider and the recording medium optimum on the basis of the controlling quantity of said fly-height-control mechanism at the time of detecting the contact and retains the controlling quantity so computed.

2. An information recording device according to claim 1, wherein said notable characteristic value is one of the amplitude of reproduced signals, the waveform of reproduced signals, timing jitters, and position data.

3. An information recording device according to claim 1, wherein said controller is configured to compute the fly-height-control mechanism's controlling quantity for making the spacing between said floating head slider and the recording medium optimum, after the assembly of the information recording device.

4. An information recording device according to claim 1, wherein said controller is configured to compute for each predetermined period, the fly-height-control mechanism's controlling quantity for making the spacing between said floating head slider and the recording medium optimum.

5. An information recording device according to claim 1, wherein the controller is configured to compute said fly-height-control mechanism's controlling quantity for making the spacing between said floating head slider and the recording medium optimum, during the idling of the information recording device.

6. An information recording device comprising:
a recording medium on which information is recorded and retained;
a floating head slider provided with a recording head by which information is recorded on said recording medium, a reproducing head by which information is reproduced from said recording medium, and a fly-height-control mechanism for controlling the distance to said recording medium; and
a controller for controlling said fly-height-control mechanism,
wherein said controller is configured to take samples of a notable characteristic value from signals reproduced by said reproducing head while reducing the spacing between said floating head slider and the recording medium gradually, produce a signal which is the sample characteristic value from which components, whose frequencies are not higher than five times the rotational frequency of said recording medium are removed, detect said floating ahead slider's contact with the recording medium when the fluctuation of the signal so produced exceeds a reference value, and compute the fly-height-control mechanism's controlling quantity for making the spacing between said floating head slider and the recording medium optimum on the basis of the controlling quantity of said fly-height-control mechanism at the time of detecting the contact and retains the controlling quantity so computed.

7. An information recording device according to claim 6, wherein said notable characteristic value is one of the amplitude of reproduced signals, the waveform of reproduced signals, timing jitters, and position data.

8. An information recording device according to claim 6, wherein the controller is configured to compute said fly-height-control mechanism's controlling quantity for making the spacing between said floating head slider and the recording medium optimum, after the assembly of the information recording device.

9. An information recording device according to claim 6, wherein the variation of said notable characteristic values is retained as a reference signal before detecting said floating head slider's contact with the recording medium and, on the basis of a signal which is the sample characteristic value from which said reference signal is subtracted, a signal is produced from which components, whose frequencies are not higher than five times the rotational frequency of the recording medium, are removed.

10. An information recording device comprising:
a recording medium on which information is recorded and retained;
a floating head slider provided with a recording head by which information is recorded on said recording medium, a reproducing head by which information is reproduced from said recording medium, and a fly-height-control mechanism for controlling the distance to said recording medium; and
a controller for controlling said fly-height-control mechanism,
wherein said controller is configured to take samples of a notable characteristic value from signals reproduced by said reproducing head while reducing the spacing between said floating head slider and the recording medium gradually, produce a signal which is the sample characteristic value from which components of frequencies in the vicinity of the resonant frequency of said floating head slider are extracted, detect said floating head slider's contact with the recording medium when the fluctuation of the signal so produced exceeds a reference value, and compute the fly-height-control mechanism's controlling quantity for making the spacing between said floating head slider and the recording medium optimum on the basis of the controlling quantity of said fly-height-control mechanism at the time of detecting the contact and retains the controlling quantity so computed.

11. An information recording device according to claim 10, wherein said notable characteristic value is one of the amplitude of reproduced signals, the waveform of reproduced signals, timing jitters, and position data.

12. An information recording device according to claim 10, wherein the controller is configured to compute said fly-height-control mechanism's controlling quantity for making the spacing between said floating head slider and the recording medium optimum, after the assembly of the information recording device.

13. An information recording device according to claim 10, wherein, before detecting said floating head slider's contact with the recording medium, the variation of said notable sample characteristic values is retained as a reference signal and, on the basis of a signal which is the sample characteristic value from which said reference signal is subtracted, a signal is produced from which components of frequencies in the vicinity of the resonant frequency of said floating head slider are extracted.
